(19) United States
(12) Patent Application Publication
(10) Pub. No.: US 2005/0108091 A1
(43) Pub. Date: May 19, 2005

(54) Methods, systems and computer program products for providing resident aware home management

(76) Inventors: John Sotak, Fuquay-Varina, NC (US); Eric Lomascolo, Garner, NC (US); Allen Zerumsky, Morrisville, NC (US); James Stiscia, Garner, NC (US); Robert Finley, Raleigh, NC (US)

Correspondence Address: MYERS BIGEL SIBLEY & SAJOVEC, PO BOX 37428, RALEIGH, NC, 27627, US

(21) Appl. No.: 10/714,413

(22) Filed: Nov. 14, 2003

(51) Int. Cl. G06F 17/60

(52) U.S. Cl. 705/14

(57) ABSTRACT

Resident activities and/or activity schedules are used to control a home management system. Resident activities and/or activity schedules may be monitored using a calendar application. A common repository may be provided for storing residential information used by multiple applications. Control of the home management system may include the selection of advertising video clips that may replace commercial advertisements in a vide stream. Advertising portions of a video stream may also be replaced with a locally generated video insertion. An architecture and/or system for home management is also provided.

### FIELD OF THE INVENTION

The present invention relates to electronic automation and more particularly automation systems suitable for use in a residential environment.

### BACKGROUND OF THE INVENTION

Home automation systems have traditionally involved individual systems that provided control over limited aspects of a residential environment. For example, in conventional home automation separate systems may be provided for lighting control, residential monitoring and/or security, HVAC control, video distribution, audio distribution, telephony, networking and/or smart appliances. These systems, however, typically do not function in an integrated manner but operate with only limited interaction.

For example, the security system may interact with the lighting control to turn on lights when an intrusion is detected. Also, the security system may interact with the video distribution to display camera video on a television. Likewise, the video distribution may be told to display an entry way camera when the door bell is activated. However, these interactions are typically limited and are event driven in that a user typically explicitly specifies the time and/or nature of the interaction.

Whole house automation systems have also been event driven as well. For example, a lighting system may be programmed to control the state of lights within a residence based on a programmed time, day of the week and/or date. These systems, however, are typically preprogrammed based on time of day and/or day of week and the lights controlled when the time and/or day event occurs. Similar systems are also available to control HVAC operation. Lighting scenes that consist of a particular group of light settings and/or control of other home automation components may also be programmed. These scenes are also, typically, individually selected by a user requesting the scene and/or based on a timed event.

Programmable remote control devices are also available for controlling multiple audio and/or video components. Such systems, typically, clone remote control devices for the components being controlled and may utilize macros or groups of commands to perform a series of operations. Such operations may also include operation of other home automation systems. For example, a programmable remote control may be programmed to turn on a home theater system, dim the lights in the room of the home theater and close the blinds, etc. These systems, however, also rely on direct user input to specify the operations carried out by the system and direct user selection of a sequence of operations.

Recently, efforts have been made to integrate various residential services into a single residential infrastructure. For example, a single residential access device or residential gateway may be provided to integrate telephone, cable television and networking functions. These efforts, however, have generally been focused on providing a single access point and a common format for different residential services, such as video and networking. As such, the residential gateway has not, typically, provided integration of functions provided by differing home automation systems.

With the advent of digital video recorders there have also been efforts to utilize such devices to obtain information about the user of the device and to provide targeted advertising and/or tailored video to a user. Examples of such systems include those described in U.S. Pat. Nos. 5,534,911 and 5864,823 and in U.S. patent Publication Nos. 2002/0073421A1 and 2002/0129368. Additionally, Invidi Technologies Corporation of Alberta, Canada, also has described a system for targeted advertising utilizing ad insertions. See e.g. www.invidi.com/noFlash/technology.html.

### SUMMARY OF THE INVENTION

Embodiments of the present invention provide resident aware control of a component of a home management system at a residence. Resident activities of a resident of the residence are determined and the component is controlled based on the determined resident activities of the resident.

In further embodiments of the present invention, the resident activities are determined by collecting information on activity schedules of residents of the residence utilizing an electronic calendar. Furthermore, the component may be controlled based on the determined resident activities of the resident by controlling at least one home management component of the home management system based on the information collected on the activity schedules of the residents.

The control of the component may include selecting a video insertion to replace a commercial advertising portion of a video stream based on the determined activities of the resident, detecting a commercial advertising portion of the video stream and replacing the detected commercial advertising portion of the video stream with the selected video insertion so as to provide a composite video stream containing primary content portions and the selected video insertion. The video insertion may be selected by selecting an advertisement associated with the determined activities of the resident.

In additional embodiments of the present invention, determining resident activities includes maintaining an activities schedule for the resident and determining whether the resident is present at the residence based on the resident's activities schedule. The component may be controlled by controlling access to video programming and/or network information based on the resident's activities schedule.

In other embodiments of the present invention, a video stream containing commercial advertising portions and primary content portions is displayed on a television at a residence by detecting a commercial advertising portion of the video stream and replacing the detected commercial advertising portion of the video stream with a video stream from a source component located at the residence so as to provide a composite video stream containing primary content portions and at least one locally generated portion. The video stream may include a camera output and/or a status display. For example, the video stream may be a video stream from a baby monitor.

Furthermore, information on activity schedules of the residents of the residence may be collected and the activities reflected in the collected information may be analyzed. The video stream from the source component located at the residence may be selected based on the analysis of the collected information. The information on activity schedules may be collected utilizing a calendar application.

In still further embodiments of the present invention, demographic data for residents of a residence for use in selecting video content for presentation to the residents may be generated by collecting information on activity schedules of the residents of the household, analyzing the activities reflected in the collected information and selecting video content for presentation to the residents on a television based on the analysis of the collected information. The information on activity schedules may be collected utilizing a calendar application.

Furthermore, the analysis and selection may be provided by transmitting at least a portion of the collected information to a central entity and receiving video content for presentation to the residents from the central entity. The central entity may evaluate the transmitted information to determine at least one interest of the resident and select at least one advertiser based on the determined interest. An advertising clip is requested and received from the advertiser and forwarded to the received advertising clip to the residence. The central entity may also request and receive a plurality of advertising clips. A program package incorporating the plurality of advertising clips may be generated and sent to the residence.

In still further embodiments of the present invention, analyzing the collected information is provided by analyzing the collected information so as to determine an interest of a resident associated with the collected information.

In other embodiments of the present invention, a user of a video display device is determined by collecting information on activity schedules of the residents of the residence and identifying at least one of the residents of the residence as the user of the video display device based on the collected information. The information on activity schedules may be collected utilizing a calendar application. Additionally, video content for display on a display device may selected based on the identified resident.

In additional embodiments of the present invention, identifying the resident is provided by eliminating from a list of possible users residents that the activity schedule information indicates are not present at the residence. Information on resident activities associated with corresponding residents may also be collected and the resident activities reflected in the collected information analyzed to identify interests of the corresponding residents. The identification of the resident is then provided by selecting a user from the list of possible users based on the interests of the residents and the content of video to be displayed on the display device. The collection of information on resident activities may be provided by collecting information utilizing a calendar application.

In other embodiments of the present invention, components in a home management system are controlled by maintaining a central repository of residence information for use by more than one component of the home management system. An action to control a component of the home management system is determined based on an analysis of residence information maintained in the central repository. The residence information may include demographic information of residents, resident activity information and/or activity schedules of residents.

Furthermore, the determination of an action to control a component of the home management system may include selecting a video insertion to replace a commercial advertising portion of a video stream based on the information stored in the central repository. A commercial advertising portion of the video stream may be detected and the detected commercial advertising portion of the video stream replaced with the selected video insertion so as to provide a composite video stream containing primary content portions and the selected video insertion. Selection of a video insertion may be provided by transmitting at least a portion of the information from the central repository to a central entity and receiving video content for presentation to the residents from the central entity.

Selection of a video insertion may be provided by analyzing information from the central repository so as to determine an interest of a resident associated with the information and selecting a video insertion based on the determined interest of the resident.

In still further embodiments of the present invention, determining an action includes determining an action to control at least one of a home automation system, a parental control system, a security system, a network firewall, a video system, an audio system, a telephone system and/or a residence monitoring system. Access to the central repository may be controlled with a common interface through which application programs communicate with the central repository.

In other embodiments of the present invention, a home management system includes a central repository of residence information, a family information manager configured to provide access to the central repository of residence information and a plurality of home management application programs configured to retrieve information from and/or store information in the central repository. A family information portal configured to provide an interface to the plurality of application programs may also be provided.

In further embodiments of the present invention, a direct media insertion technology (DMIT) module is configured to control the content of media distributed to devices managed by the home management system. The DMIT module may be further configured to block access to media based on information in the central repository. The DMIT may also be configured to insert advertisements into media distributed to devices managed by the home management system based on information in the central repository. The DMIT may be further configured to replace advertisements in media distributed to devices managed by the home management system with alternative media content based on information in the central repository.

In certain embodiments of the present invention, at least one of the application programs is a calendar application for tracking activities of users of the home management system. At least one of the application programs could also be a services module configured to provide sharing services that control the flow of information from the central repository, an update module that provides for updating the central repository, a Family Information Scheduling (FIS) module that provides a Family Calendar that tracks family activities, appointments and/or tasks, a Family Advertising System (FAS) module that provides tailored advertising and/or control over advertising, a Kitchen Information System (KIS)/Gourmet module provides recipes, menu planning and/or inventory functions, a Medical Information System (MIS) module that provides medical information, maintenance, control over medical records and/or exercise schedules/routines, a Landscape Information System (LIS) module that controls the schedule of maintenance and/or irrigation systems, a School Interface System (SIS) module that tracks assignments and/or activities and/or a Family Automation Control (FAC) module that controls home automation systems. The plurality of application programs may include at least two application programs configured to use information provided by the other one of the two application programs. The information used by one of the two application programs that is provided by the other one of the two application programs may be stored in the central repository.

As will further be appreciated by those of skill in the art, the present invention may be embodied as methods, apparatus/systems and/or computer program products.

### BRIEF DESCRIPTION OF THE DRAWINGS

FIG. 1 is a block diagram of a resident aware home management system according to embodiments of the present invention;

FIG. 2 is a block diagram of an exemplary resident aware home management system according to embodiments of the present invention;

FIG. 3 is a flowchart illustrating operations according to embodiments of the present invention;

FIG. 4 is a flowchart illustrating operations according to particular embodiments of the present invention;

FIGS. 5A and 5B are a flow diagram illustrating operations for resident aware advertising according to particular embodiments of the present invention;

FIG. 6 is a flowchart illustrating operations for determining a user of a video display device according to particular embodiments of the present invention;

FIG. 7 is a flowchart illustrating operations for local video insertion according to particular embodiments of the present invention;

FIG. 8 is a block diagram of a video system according to certain embodiments of the present invention;

FIG. 9 is a block diagram of a resident aware home automation system according to certain embodiments of the present invention;

FIG. 10 is a block diagram of a family information manager module according to certain embodiments of the present invention; and

FIG. 11 is a block diagram of a direct media insertion technology (DMIT) module according to certain embodiments of the present invention.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Various embodiments of the present invention will now be described with reference to the figures. However, the present invention should not be construed as limited to use in systems such as those illustrated in the figures but may be used in any system capable of carrying out the operations and/or functions described herein.

Embodiments of the present invention provide for resident aware control of aspects of a residence. In particular, embodiments of the present invention provide a resident aware home management system. As used herein, the term residence refers to a house and any associated property. Thus, for example, a camera that monitors a residence may monitor the interior or exterior of a house and/or a portion of the property associated with the house, such as a driveway or entry gate. As used herein, a home management system refers to a process and/or system that provides the ability to enhance one's lifestyle, make a home more comfortable, safe and/or efficient and may include home automation systems.

Certain embodiments of the present invention stem from a realization that the activities of residents that are independent of operation of specific component of a home management system may dictate operation of the component. Thus, for example, a family going on vacation may result in changes in the operation of several components of a home automation system, including, for example, adjusting the HVAC system, setting the alarm system, powering down home theater and/or audio systems, changing a lighting schedule or the like. However, these individual operations of components of the home automation system are driven by the independent activity of going on vacation. Thus, certain embodiments of the present invention provide for identify and/or tracking activities of residents rather than direct control of components of a home management system. Additional embodiments of the present invention provide architectures and/or systems that may facilitate such identification and/or tracking. The architectures and/or systems may also allow for cooperation/information exchange between components that may further identify and/or leverage such information.

As used herein, the term “resident activity” or “resident activity information” refers to activities and/or information about activities of a resident of the residence that are independent of activities that control a specific device in the home management system. Thus, for example, a resident activity may be the resident's participation in a soccer game or school play. Resident activity information could also be information about a resident's activities in controlling a device or component of the home management system but the information is used by a controller to control a different device than the one that the resident's activities controlled. Thus, for example, the resident's web browsing habits could be used to control content provided on a home entertainment system. Also, a resident's activities in use of an audio system could be used in deciding what to provide as an insertion to replace advertisements in a television program. In contrast, information about activities of the resident to control a device that are used to control that same device would not be a “resident activity” or “resident activity information” as those terms are used herein.

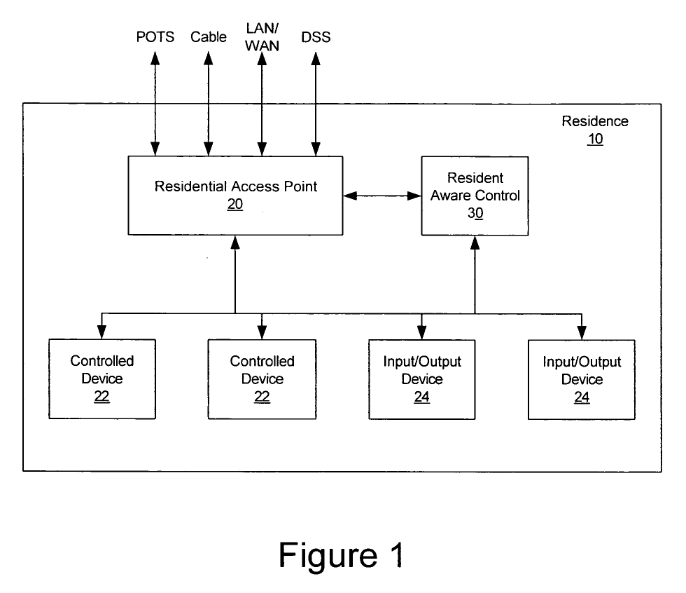

FIG. 1 illustrates an exemplary home management system incorporating embodiments of the present invention. As seen in FIG. 1, a residence 10 may include a residential access point 20 that provides access to the residence 10 for communications/information medias, including for example, POTS (plain old telephone service), cable television, local and/or wide area wired and/or wireless networks (LAN/WAN) and/or digital satellite service (DSS). Other types of media access to the residence 10 may also be provided. For example, fiber optic communications could also be provided to the residence 10. Accordingly, embodiments of the present invention should not be construed as limited to the particular types of media services described herein.

The residential access point 20 provides for distribution of the various medias throughout the residence 10 in their original format and/or in a converted or modified format. For example, video and/or telephone service could be distributed throughout the residence over a TCP/IP network, either wired or wireless, and/or distributed over a coaxial cable distribution system.

The residential access point 20 may also control devices in the residence 10. For example, the residential access point may transmit wireless and/or wired control signals, such as X10, RS232, Ethernet or other such signals, to devices within the residence 10 so as to control the devices. The residential access point 20 may also provide the media to controlled devices 22 and/or input/output devices 24. Examples of controlled devices 22 may include light control modules, appliance control modules, HVAC controllers, audio visual equipment, security systems and/or other home automation components. Examples of input/output devices 24 may include personal computers, laptop computers, pervasive computing devices, such as personal digital assistants, smartphones, or the like, keypads, touchscreen displays or other display devices, including, for example, televisions and/or other devices capable of displaying information to and/or receiving information from a resident of the residence 10. Particular devices may function as both a controlled device 22 and an input/output device 24.

Also illustrated in FIG. 1 is a resident aware control device/module 30. The resident aware control module/device 30 may be provided as a stand-alone system, for example, an application executing on a data processing system, such as a personal computer, server or the like, or may be provided as part of another system, such as the residential access point 20. The resident aware control module/device 30 may be provided as part of a web server and the web server may be provided at the residence, partly at the residence and off-site or entirely off-site.

The resident aware control device/module 30 controls the media provided to controlled devices 22 and/or input/output devices 24 and gathers information from the controlled devices 22 and/or input output devices 24. The resident aware control device/module may also provide services to the residents and/or control the operation of the controlled devices 22 and/or input output devices 24. The information gathered may be directly input by a resident and/or may be determined based on actions of a resident, including, for example, operation of a controlled device 22 and/or an input/output device 24. At least some of the information gathered by the resident aware control device/module 30 includes information about activities and/or activity schedules of a resident of the residence 10. The resident aware control device/module 30 may also gather information from sources external to the residence 10, for example, from the Internet, an information service, such as a TiVO or ReplayTV service, or from a centralized information service associated with the resident aware control device/module 30.

The resident aware control device/module 30 controls the controlled devices 22 and/or input/output devices 24 based on an analysis of the collected information to determine activities of a resident of the residence 10. Thus, for example, the resident aware control device/module 30 may collect information on the schedule of a resident, analyze the schedule to determine activities of the resident and control the media presented to that resident based on the determined activities. Accordingly, information that is independent of the direct control of a controlled device 22 and/or input/output device 24 may be used to control the devices. For example, the resident aware control device/module 30 may maintain a central repository of residence information for use by more than one component of the home management system and inferentially determine an action of a component of the home management system based on an analysis of residence information maintained in the central repository.

While embodiments of the present invention are described with reference to the particular system configuration illustrated in FIG. 1, as will be appreciated by those of skill in the art, other configurations may also be utilized while still benefiting from the teachings of the present invention. For example, the residential access point 20 may be replaced with a conventional media distribution system that distributes media in the residence 10 in its native format. Thus, the present invention should not be construed as limited to the configuration of FIG. 1 but is intended to encompass any configuration capable of carrying out the operations described herein.

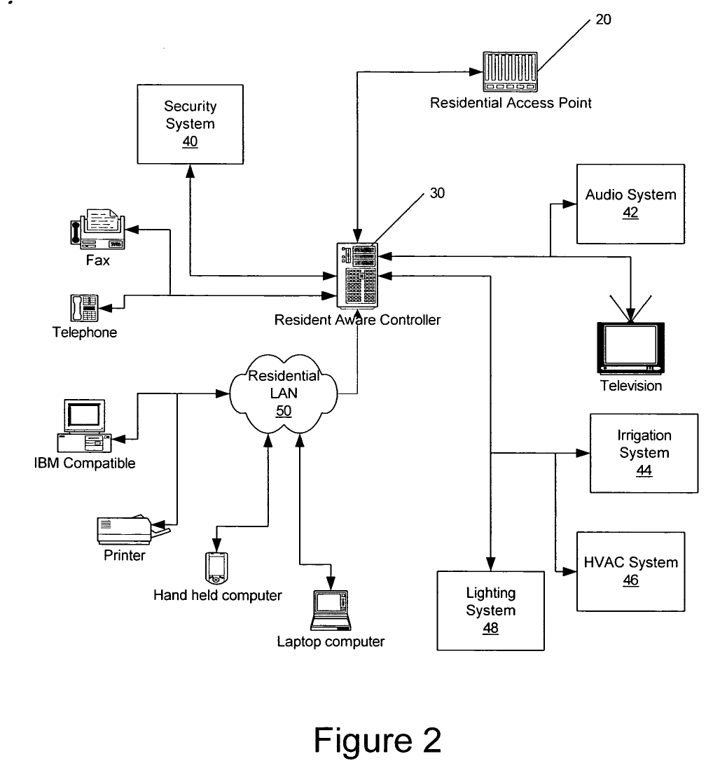

FIG. 2 is a block diagram illustrating a specific example of home management system according to embodiments of the present invention. As seen in FIG. 2, the resident aware controller 30 communicates with various devices in the residence. For example, the resident aware controller 30 receives and/or provides telephone, video and other media from/to the residential access point 20.

The resident aware controller 30 may also communicate with controlled devices and/or input/output devices, such as a security system 40, an audio system 42, an irrigation system 44, an HVAC system 46 and a lighting system 48. The resident aware controller 30 may communicate with the security system 40, the audio system 42, the irrigation system 44, the HVAC system 46 and/or the lighting system 48 utilizing a component specific communication media and/or a general purpose communications media. For example, one or more of the security system 40, the audio system 42, the irrigation system 44, the HVAC system 46 and/or the lighting system 48 could be capable of communicating over a network, either wireless or wired, such as the residential LAN 50.

Additionally, the resident aware controller 30 may communicate with data processing systems, such as one or more laptop computers, hand held computers, printers and/or desktop computers over the residential LAN 50. The resident aware controller 30 may also communicate with a fax and/or telephone utilizing conventional twisted pair wiring or over the residential LAN 50 utilizing voice over IP techniques. The resident aware controller 30 may also communicate with a television, for example, by providing a video signal to the television.

While the example illustrated in FIG. 2 illustrates separate communications mechanism between the different components of the system, other configurations may also be utilized. For example, each of the components may communicate over the residential LAN 50. In such a case, conversion boxes may be provided for devices that do not directly support network communications. For example, a set top box or digital video recorder could be utilized at a television to convert the network communications to an audio/video signal for display by the television or distribution to other devices. Thus, the present invention should not be construed as limited to a particular configuration or communication mechanism between the resident aware controller 30 and the controlled and/or input/output devices.

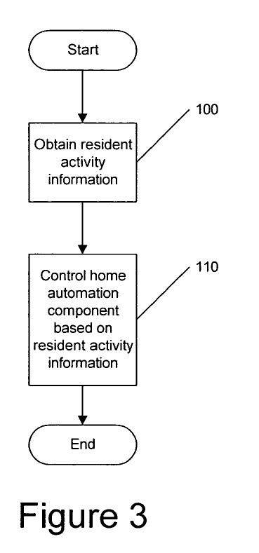

As mentioned above, embodiments of the present invention may provide for control of a home management component, such as those illustrated in FIG. 2, based on resident specific information. FIG. 3 illustrates operations carried out by the resident aware controller 30 according to certain embodiments of the present invention. As seen in FIG. 3, the resident aware controller 30 obtains resident activity information (block 100). The resident activity information may be obtained by direct input, such as through a calendar, or through monitoring of the resident's activities. For example, resident activity information could be obtained by monitoring music listened to by a resident, programs viewed by the resident and/or web browsing activity of the resident. Note, however, that such information would not be considered resident activity information when such information is used to control the device from which it is obtained. Thus, for example, music listened to by a resident would not be resident activity information when used to select music to play for the resident. Likewise, program monitoring information would not be resident activity information when used to select programming for the resident. Finally, web activity would not be resident activity information when used to provide web content to the user. However, web activity information can be resident activity information if used, for example, to select music to play for a user or programming to provide to the user.

The resident aware controller 30 controls at least one home management component based on resident activity information (block 110). For example, information about a resident going on vacation that is provided to a calendar function of the resident aware controller 30 could be used by the resident aware controller 30 to control the HVAC system 46 to adjust the thermostat setting.

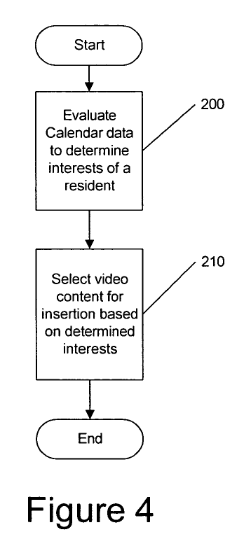

FIG. 4 illustrates further embodiments of the present invention where the resident aware controller 30 provides a family calendar application in which residents of the residence enter activities, appointments and/or tasks. As seen in FIG. 4, the resident aware controller 30 evaluates the calendar data to determine interests of a resident (block 200). This evaluation may be carried out by the resident aware controller 30 or by another entity, such as a remote evaluation service, for example, by forwarding the information over the Internet, an extranet and/or a dial-up service. The evaluation may be carried out according to conventional data mining techniques and, accordingly, will not be described further herein.

Based on resident interests, video content is selected for insertion in a video stream by the resident aware controller 30 (block 210). The resident aware controller 30 may then insert the selected video content into a video stream provided to a display device, such as the television of FIG. 2. For example, targeted advertisement material may be selected based on resident interests identified by evaluation of the calendar. The advertisements may then be inserted in place of advertisements provided with a video stream, for example, advertisements provided in a cable television or satellite television video signal. Such insertion of advertisement may be carried out as described below with reference to the insertion of locally generated content.

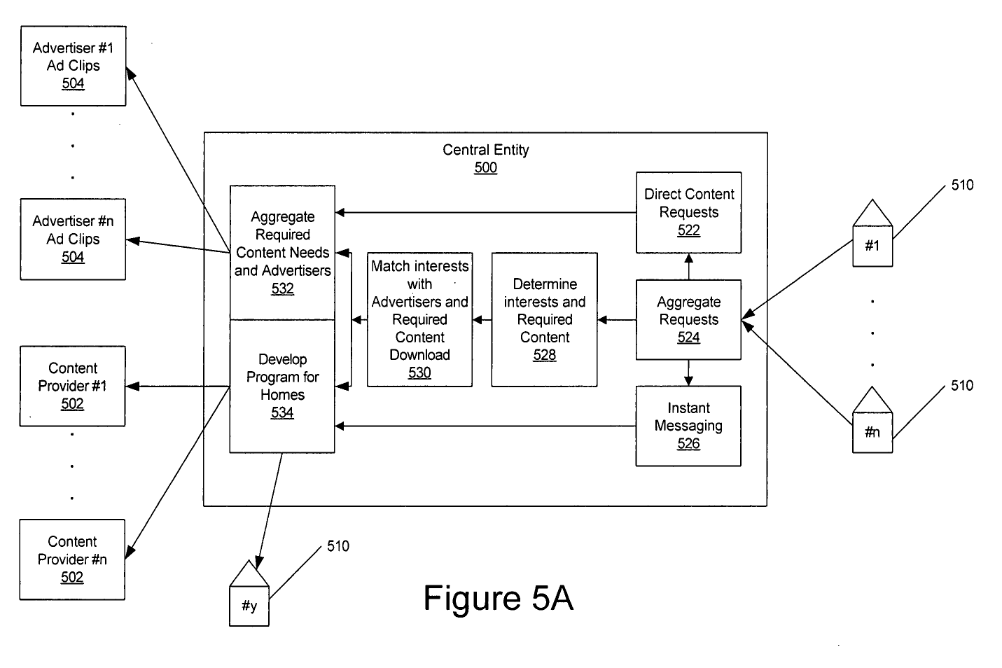

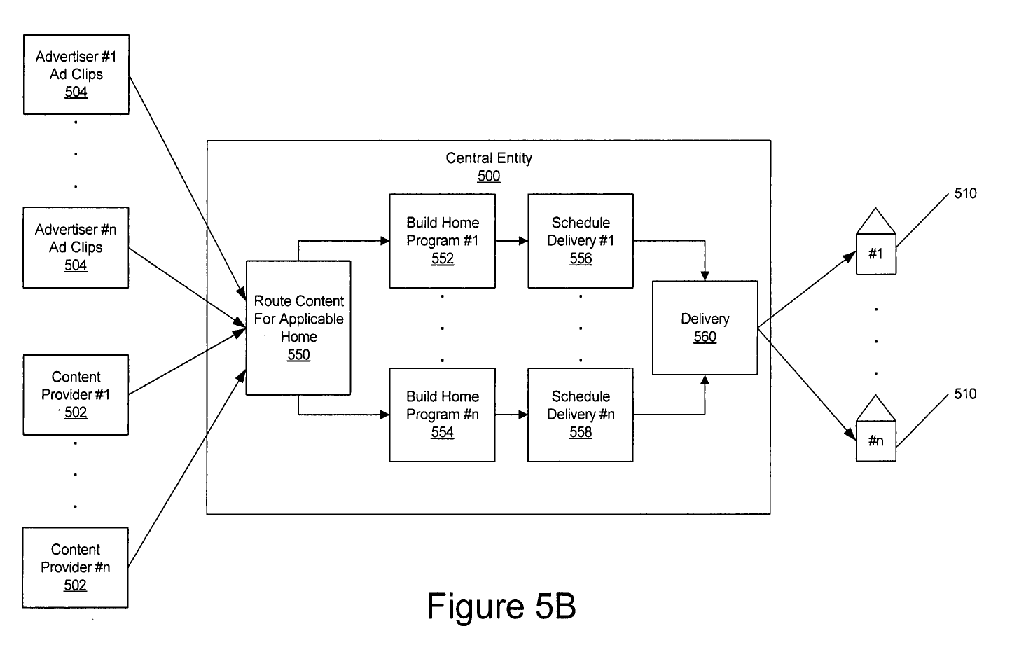

FIGS. 5A and 5B illustrate operations where a central entity 500 receives information for the resident aware controller 30 and provides content for display in the residence. FIG. 5A illustrates the flow of information from residences and FIG. 5B illustrates the flow of information to residences. As seen in FIG. 5A, a plurality of residences 510 may provide information regarding the activities of a resident. Such information may be acquired as described above, for example, through the use of a calendar that tracks activities, appointments and/or tasks of a resident. The information may be provided in its stored format or may be further processed and/or analyzed by the resident aware controller 30 at the particular residence 510. For example, the information could be stripped of date and/or time information or could be processed and provided in a canonical form to the central entity 500. The information may be provided from the resident aware controller 30 over a communications media, such as via modem, cable and/or DSL modem, wireless or wired network or other such communications media.

The central entity 500 receives the information from the residences 510 as requests for content and aggregates the requests (block 524). The requests may be evaluated and direct requests for content (block 522) and instant messages (i.e. messages to another residence accessible to the central entity 500)(block 526) are identified (block 522). For example, a resident may provide a direct request for content by requesting specific advertisements or advertisements on a specific topic. Such direct requests could be obtained from the resident, for example, by the resident updating a profile of the resident that is maintained by the resident aware controller 30. Alternatively, the requests could be obtained in an interactive session utilizing web pages generated by the resident aware controller 30 and displayed to the resident on a networked device, such as a laptop, desktop and/or PDA or through a set top box and a television, touch screen or other control interface.

A resident could provide an instant message through, for example, a web interface provided by the resident aware controller 30 to a networked device, such as a laptop, desktop and/or PDA or through a set top box and a television, touch screen or other control interface. Additionally, the instant message may be a message to control a device at another residence and could be generated by the resident aware controller 30 based on resident activities as discussed above. Thus, for example, a resident aware controller 30 in a first residence could send an instant message to a resident aware controller 30 in a second residence to control devices in the second residence. For example, if the calendar at the first residence indicated that the resident was going on vacation to their beach house (the second residence) on a particular day, a message could be sent to adjust the temperature of the HVAC from a vacant setting to an occupied setting. Similarly, if the resident was interested in monitoring the second residence, the first residence could send a requesting video from a surveillance camera at the second residence that could be incorporated into a video stream or otherwise played back at the first residence.

Returning to FIG. 5A, the aggregated requests are also evaluated to determine the interests of the residents and any required content for the requests (block 528). Such evaluation may include identifying activities of residents and, based on such identified activities determining content that may be of interest to the residents. Such an analysis may take the form of conventional demographic modeling utilizing the information obtained from resident aware controllers 30 as demographic information for the residents. The determined interests of the residents are then matched with advertisers and the required content download identified (block 530). The required content and advertisements are aggregated (block 532) and a program developed for individual residences (block 534) based on the direct content requests, the evaluation results and/or the instant messaging information. The advertisers 504 and/or content providers 502 are contacted to request the identified advertisements and/or program content.

FIG. 5B illustrates the flow of information responsive to the requests from the central entity 500. As seen in FIG. 5B, the advertisement clips and/or content are obtained from the advertisers 504 and/or content providers 502 and route the content for the applicable residence 510 (block 550). The particular programs are built for a given residence 510 from the received advertisements and/or contents (blocks 552 and 554). When sufficient advertisements and/or contents are obtained for a particular residence 510 to provide a program, the program is scheduled for delivery to the residence 510 (block 556 and 558). The scheduled programs are the delivered to the residences 510 (block 560). The program may be delivered over the same communications media that the requests (FIG. 5A) were received or over a different communications media. For example, the programs could be delivered as digital files, such as MPEGs, and the program reassembled by the resident aware controller 30 at a residence 510. The programs could also be delivered as analog video streams, for example, over a cable distribution system.

Thus, as illustrated in FIGS. 5A and 5B, programs may be constructed based on interests of a resident that are inferred from activities in which the resident participates. The information about the activities in which the resident participates may be obtained by a resident aware controller 30. Thus, a personalized program may be provided to the resident. The actual delivery of the program (e.g. by display on a television) may be in “real time” (i.e. as the program is received at the residence 510) and/or may be delayed and stored at the residence 510 for subsequent playback. Where the program includes tailored advertisements, these advertisements may be incorporated into content not received with the program. Thus, for example, the advertisements in a commercial television broadcast, such as a network television broadcast, may be replaced by advertisements from the received program. Such a replacement may be made, for example, based on a determination of the resident watching a television program.

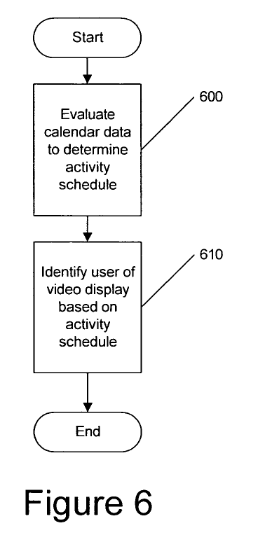

FIG. 6 illustrates operations according to certain embodiments of the present invention for determining a user of a video display (e.g. a resident watching television). Such a determination may be particularly useful in embodiments of the present invention that provide custom advertising based on resident activities and/or embodiments of the present invention that provide parental control of content based on resident activity information. As seen in FIG. 6, the resident aware controller 30 evaluates the calendar data to determine activity schedule information of a resident (block 600). This evaluation may be carried out by the resident aware controller 30 or by another entity, such as a remote evaluation service, for example, by forwarding the information over the Internet, an extranet and/or a dial-up service as described above. The activity schedule information identifies activities that the residents of a residence are participating in, when those activities are occurring and/or which residents are participating in the activities. A determination may also be made as to whether the activity occurs within the residence or outside the residence.

Based on the activity schedule, a determination is made as to which resident and/or group of residents could be watching the video display (block 610). Such a determination may also be augmented by further information, such as information about the program being viewed, remote control activities or other techniques for determining a user of a video display device. Additionally, information about the interests of a resident could also be utilized in combination with the activity schedule to identify a user as well as information about the display device being utilized, such as the location of the display device. Thus, for example, if the activity schedule indicates that the parents in a residence are attending a play, then the parents are eliminated from the possible choices as a user of the video display device. The identification of the user may be used in controlling operation of the device, including selection of content to be provided to the device as described above.

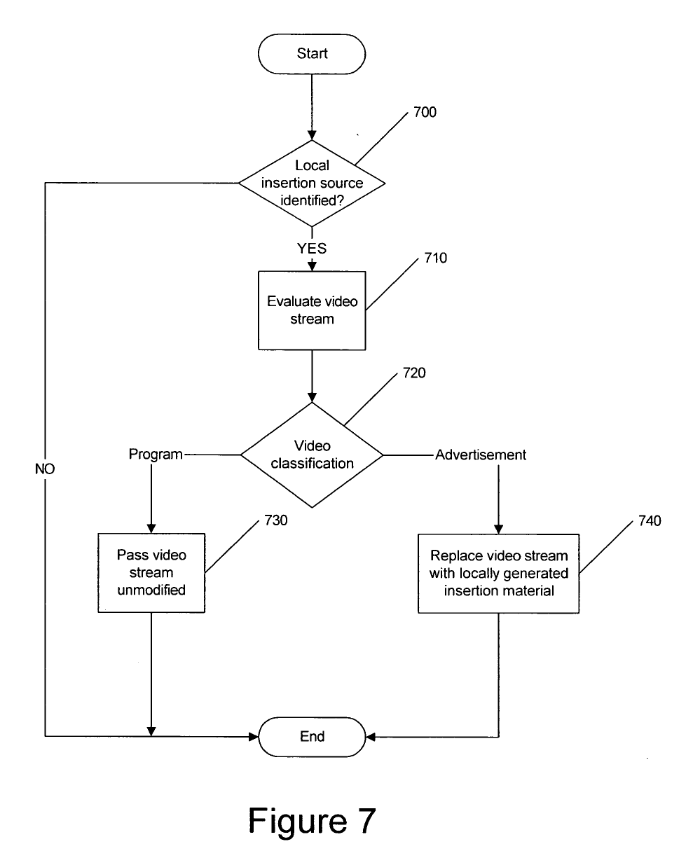

FIG. 7 illustrates further embodiments of the present invention where locally generated insertions are utilized to replace advertisements in a video stream, such as a commercial broadcast video stream. As used herein, a locally generated insertion refers to an insertion that is generated within a residence. Thus, for example, video from a surveillance monitor at the residence, a web cam at the residence and/or a baby monitor would be considered locally generated. In contrast, playback of a downloaded commercial would not be considered locally generated.

As is seen in FIG. 7, if a local insertion source is not identified (block 700), operations illustrated in FIG. 7 are bypassed. If a local insertion source is identified for providing video for insertion into a video stream (block 700), the video stream is evaluated to identify program and advertisement portions of the video stream (block 710). The local insertion source may be expressly identified, for example, by a resident requesting that a baby monitor be used as the local insertion source, or it may be determined based on resident activity information, such as determining that the time of day is past the babies bed time and that a parent is watching television. However the local insertion source is identified, the results of the evaluation of the video stream are used to classify the video stream as either a program portion (block 720) which is passed unmodified (block 730) or an advertisement portion (block 720) which is replaced by the locally generated insertion material (block 740). As a result, the detected commercial advertising portion of the video stream is replaced with a video stream from a source component located at the residence so as to provide a composite video stream containing primary content portions (the program) and at least one locally generated portion (the locally generated insertion).

The composite video stream may be generated by, for example, modifying the commercial advertising portion of the video stream to insert the locally generated video stream and/or by tuning the receiver to a new channel that contains the locally generated video stream and then returning to the channel on which the program content is provided when the advertisement portion has concluded. Techniques for evaluating video streams to detect advertising portions are known to those of skill in the art.

Video can be delivered in both analog and digital formats. In analog format it can be provided over standard cable or broadcast RF modulated frequencies or via baseband (component or composite) formats. In digital format it may be provided in MPEG2, HDTV, or JPEG formats. Thus, multiple methods of commercial detection and splicing of content may be utilized. For digital video streams the DVS 380 (ANSI/SCTE 30 2001) and DVS 253 (ANSI/SCTE 35 2001) standards provide methods of detecting avails (i.e. appropriate ad insertion points) and splicing of content into the appropriate time slots. The methods provide for in band signaling which can be decoded by a suitable decoder. However, there is also an encryption capability specified which would be used by broadcasters to prevent access to avails. If the digital video stream is encrypted or the standardized formats not supported then another method may be utilized. For this case, the analog video stream (i.e. feeding the TV set) may be used to detect avails and insert content. A number of criteria may be utilized in combination to perform this function. The energy level of the video content may be monitored for fades to low levels (i.e. commercial transitions). Pattern matching based upon temporal stimuli may be measured. An absolute timing reference may be needed (e.g. a clock identifying the time of day). Inter-gap timing of commercials is possible based upon short term and long term patterns. As such, energy level transitions can be utilized to trigger time based insertions of commercials. Knowing the time of day the expected commercial behavior can be looked up based upon previous history and pattern matching criteria measured. For example, typical single commercial slots run for 30 seconds with multiple commercials running serially in time. Thus, a short term timer would indicate the individual commercial slots while a longer term timer would be used to indicate the commercial period time. Audio levels can be monitored for average level shifts for further information.

In cases where it is desirable not to replace avail content within a broadcast video stream an automatic channel change to a specified channel could occur for display of advertising, information, or user defined content. In effect, an automatic channel change would be provided upon commercial detection. Multiple channels with each targeted at a specific reside, group of residents, or extended group of residents could be selected from.

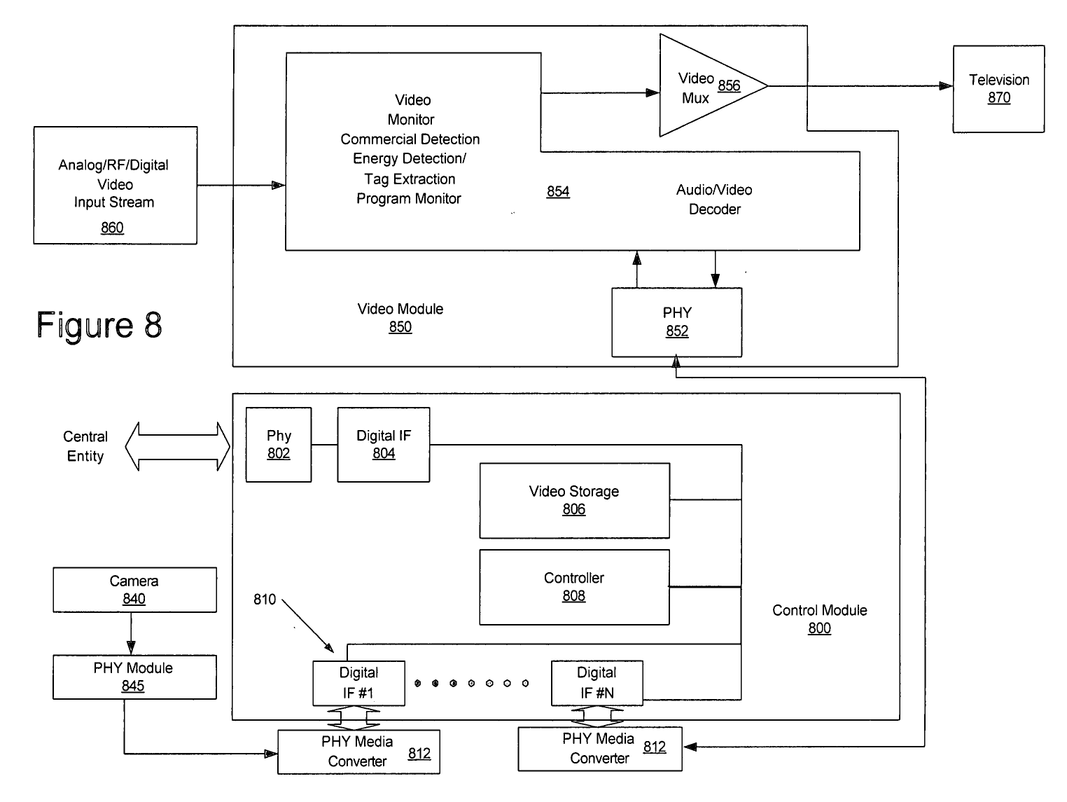

FIG. 8 is a block diagram of an exemplary system capable of providing local insertions as illustrated in FIG. 7 and/or tailored advertising as illustrated in FIGS. 4, 5A and 5B. As seen in FIG. 8, a control module 800 includes a physical interface (PHY) 802, a digital interface 804, a video storage 806 and controller 810. One or more digital interfaces 810 and corresponding PHYs and media converters 812 may also be provided. The PHY 802 and digital interface 804 may be utilized to communicate with a central entity, such as the central entity 500 of FIGS. 5A and 5B. The video storage 806 and controller 808 may be utilized to store video content to be provided by the control module 800 for insertion into a video stream. The digital interfaces 810 and PHYs and media converters 812 may be used to communicate with other devices for transmitting and receiving video content. For example, the digital interfaces 810 and PHYs and media converters 812 may communicate with a PHY 845 of a local camera 840.

The digital interfaces 810 and PHYs and media converters 812 may also be used to communicate with a video module 850 that provides the insertion of the video content into a video stream provided to a television 870. The video module 850 may receive an analog, RF and/or digital video stream 860. The video module 850 includes an audio/video decoder and video monitor 854 that provides various techniques for advertisement detection based on the available information and format of the video signal. Such techniques are known to those of skill in the art and are described further below. The video module 850 also includes a video multiplexer 856 that combines video information to provide the composite video stream to the television 870.

In operation, the control module 800 receives video content from the central entity and/or the camera 840, stores the content and provides the stored content to the video module 850. The video module 850 receives the video input stream, detects advertisements in the video stream and replaces the advertisements with the video content received from the control module 800. The control module 800 and the video module 850 may be provided in a single or multiple devices. Furthermore, the control module and/or video module may be provided as part of the resident aware controller 30.

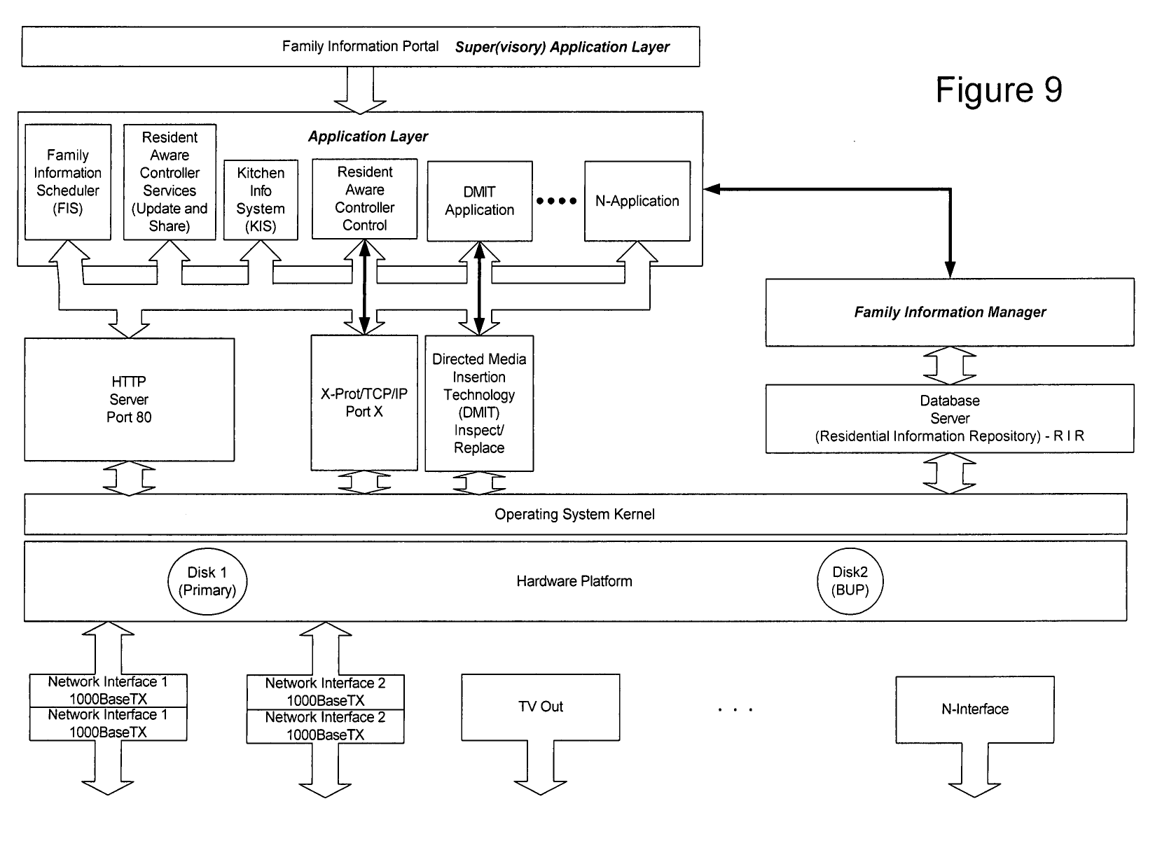

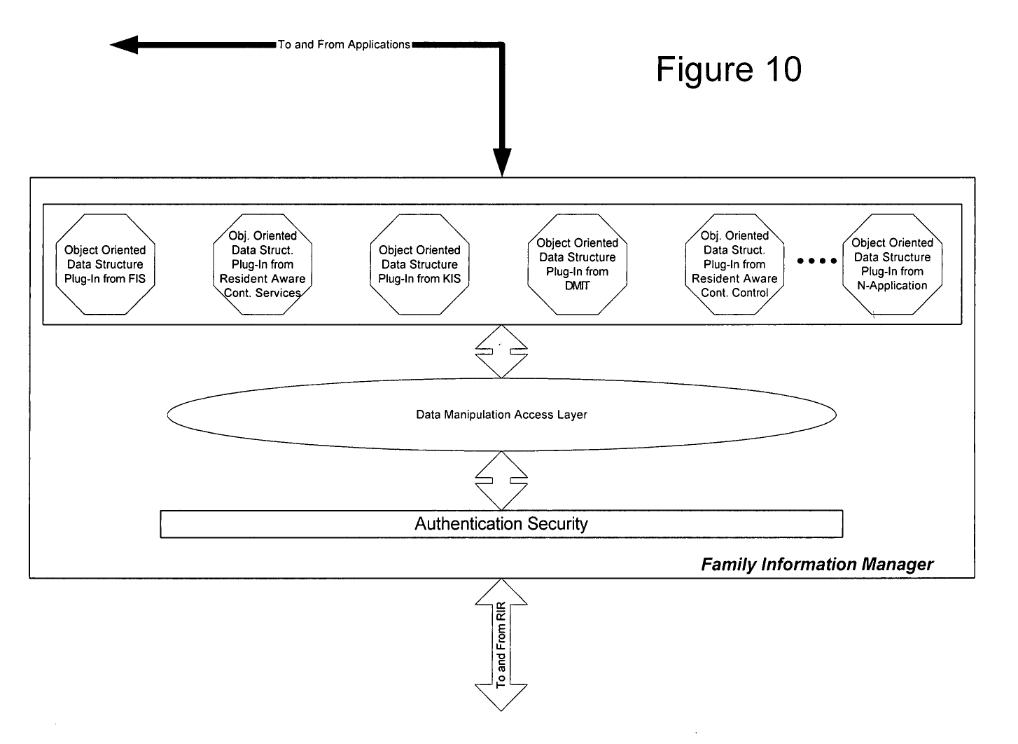

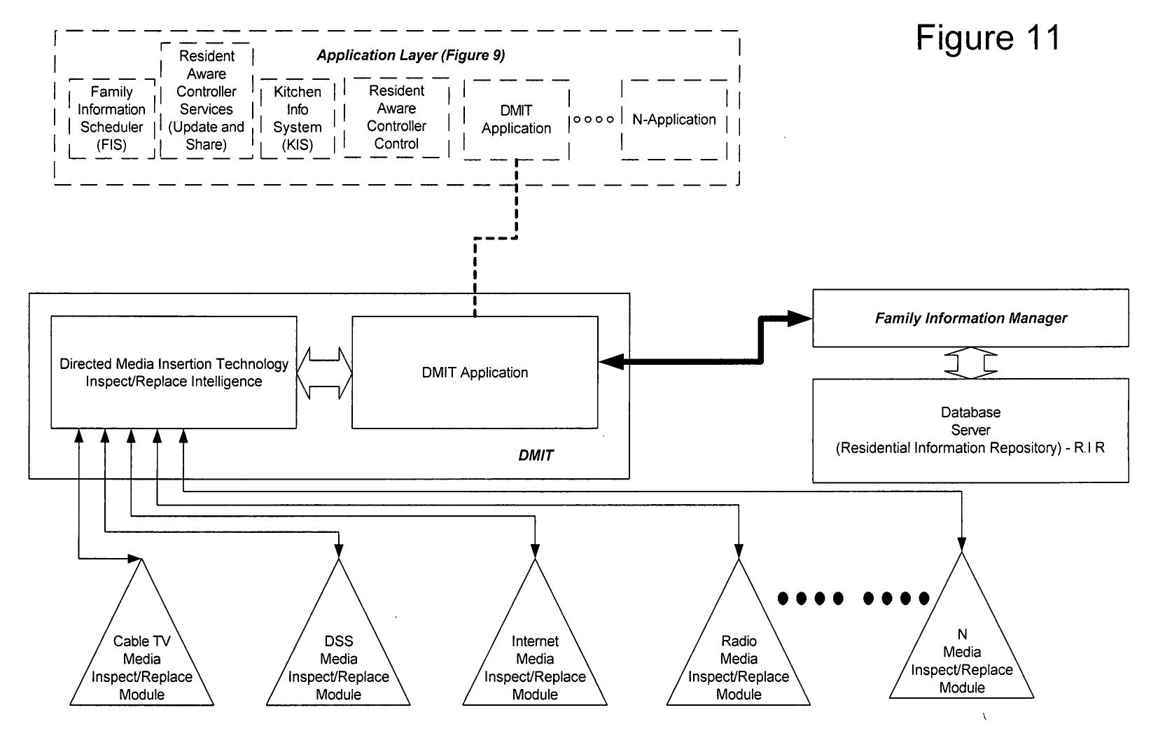

FIG. 9 illustrates an architecture and/or system according to further embodiments of the present invention. The architecture and/or system illustrated in FIG. 9 integrates family scheduling, home automation, directed media insertion technology (DMIT) and a central Residential Information Repository (RIR), through a home network; wired or wireless. Access is provide by a variety of input/output medium to include, for example, PDAs, personal computers, web-tablets, televisions, touch-panels; radios; PVR/DVRs; etc. The information is then distributed over the residential network to all communication equipment in the home.

In overview, a residential information repository (RIR) provides a database for storing information about the residents and/or residence. Access to the RIR is provided through the Family Information Manager (FIM). The FIM provides a common interface to the RIR for the application layer modules. The FIM may also allow or provide for information sharing between the application modules and/or provide control of information that may be shared between the application modules.

The application modules at the application layer provide various functionality of the system. For example, a services module may provide sharing services that may control the flow of information from the RIR and an update module that provides for updating the RIR. For example, an extended family information service may be provided to allow for sharing of information between RIRs of different residences. A Family Information Scheduling (FIS) module may provide a Family Calendar that may track family activities, appointments and/or tasks. A DMIT application module may provide for direct media insertion, such as, tailored advertising and/or control over advertising. A Kitchen Information System (KIS) module may provide recipes, menu planning and inventory functions. A Resident Aware Controller Control module may control home automation systems. Additional applications (illustrated as N-Application) may also be provided. For example, A School Interface System (SIS) module may track assignments, activities or the like. A Medical Information System (MIS) module may provide medical information, maintenance and control over medical records, exercise schedules/routines or the like. A Landscape Information System (LIS) module may control the schedule of maintenance and/or irrigation systems. Examples of certain of these modules are described in more detail below.

Access to the application modules is provided through the Family Information Portal (FIP) which may be a conventional web portal. A direct media insertion technology (DMIT) layer provides for the insertion of content into media streams as discussed above and in more detail below. The HTTP server may be a conventional web server and may provide access to user specified information for the DMIT application.

The hardware platform and operating system kernel are conventional data processing systems and may be any data processing system that supports the software layers of the architecture/system of FIG. 9. As is illustrated in FIG. 9, the hardware may include multiple disk drives to provide redundancy/backup. The network interfaces, television/audio outputs and home automation interface illustrated in FIG. 9 are examples of the connectivity that may be provided. These interfaces may be utilized for communication and/or control of devices and/or other systems, such as the central entity described above.

Certain of the components of the architecture/system of FIG. 9 will now be described in further detail.

Residential Information Repository (RIR)

The RIR is at the core of all other application services provided by the system. The RIR may be a relational database. The choice of database application may be based on the ease of use required by the system. The use of the RIR may be transparent to the end-user, who, in this case is defined by a Family. The RIR provides a centrally managed location for data that is shared by Family Users.

To keep the database application server transparent, the RIR may include several automated services that support the management and administration of the database application. These services may include, Initial Architecture/Schema Setup and Design, Change Control for New Family Data and Applications, Data backup, Migration, and Vaulting, Reorganization Data Maintenance and/or Security. As an example, an Initial Architecture/Schema Setup and Design service may be initiated by an HTML setup process where the Head Family user is asked a series of questions regarding the use of the system. When all of the appropriate information is gathered, the system creates the initial instance of the Family Database for the RIR and inserts all appropriate tables based on the system's initial release designs.

Family Information Manager (FIM)

This software layer manages access to the RIR. The FIM is the common access point between applications and the RIR. The FIM provides security by applying access control mechanisms between the user applications and the database. Additionally, it provides a common methodology for retrieving commonly used family information from the RIR while still allowing standard Structured Query Language access.

During initial setup of the system, family usernames, personal information, and security information are entered through FIM. Each family member has access privileges assigned to them to control read, write, and delete access to family information objects within the system. As an example, the head of household would have the access role to all family information objects beyond his or her own information; an offspring of the family may have read (view) access that pertains to the head of household and those information objects that pertain to him or her. The family phone/contact data should be available to all, but not necessarily available for deletion or modification from all family members. Additionally, there may be phone/contact data that should not be viewed, modified, or deleted by other family members.

The FIM acts as a proxy between the user or application and the RIR. Applications will make calls to read, write, or delete family information based on permissions that are assigned within FIM. Applications will have the ability to make standard query requests through FIM to access data and populate the application. Applications will access the RIR through application interface calls that will expose and give structured access to information appropriate to the security access mechanisms. Ad Hoc Structured Query Language retrieval will be sent through FIM to RIR and not directly to RIR.

A particular example of the FIM is further illustrated in FIG. 10. As seen in FIG. 10, the FIM may provide a plurality of plug-ins to provide object oriented data structures to allow communications with the individual applications. Thus, for example, a FIS objected oriented data structure plug-in may be provided to allow access to the RIR by the Family Information Scheduler through the FIM. Corresponding object oriented data structure plug-ins may be provided for the Resident Aware Controller services application, the KIS application, the DMIT application, the Resident Aware Controller control application and any additional applications illustrated as N-application in FIG. 10.

As is further illustrated in FIG. 10, the FIM includes a data manipulation and access layer and an authentication security layer. The data manipulation and access layer provides rules that define what data of the RIR may be accessed and how that data may be manipulated by the FIM and/or the applications. These rules may be statically defined and/or dynamically created. For example, the rules may be established at an initial set up time or may be dynamically created based on the addition and/or removal of applications. Furthermore, the rules may allow the FIM to act as an information broker between the applications. For example, the data manipulation and access layer may provide for reading, writing, forwarding, filtering and other access of the data by the applications. The authentication security layer controls access to the RIR and may provide, for example, application and/or user level access control to the RIR.

Family Information Portal (FIP)

The FIP is the upper most software layer within the system. The FIP is a web-based application that users will, typically, most often use to access the systems' applications and other Internet content. In particular embodiments, the FIP is a web-based menu system for direct access to the family information that is accessible by the lower level applications. The portal system is dynamic in nature and may not require the user to be a web developer to maintain it. Each view into the system may be customizable by each user that accesses the portal.

The Family Information Portal gives access to the family at a glance and by click, all family information. The portal is customizable around the Family Information applications and other Internet applications that conform to the Family Portal standards. The Family Information Portal allows the mix of both Family Information access and Internet content access simply by being a web-based application that is served by the system over the family network and primarily runs on a web browser client system. The Family Information Portal may replace the default “HOME” link for the web browser client. Instead of having the web browser point to a standard web site or hyper link, the web browser will point to the Family Information Portal located on the system.

The initial architecture/schema setup and design of the FIP may be provided by a service that is transparently initiated by an HTML setup process where the Head Family user is asked a series of questions regarding the use of the system. When all of the appropriate information is gathered, the system creates the initial instance of the Residential Database for the Residential Information Repository (RIR) and inserts all appropriate tables based on the system's initial release designs.

Directed Media Insertion Technology (DMIT)

The DMIT allows the system to be in charge of information flow into and out of the home. DMIT is not in-band with the information flow but rather is out of band of the information. DMIT controls the flow of information through the use of an Inspection/Replace architecture. Each medium is considered a network technology. Cable TV has a single insertion point into the home that is then distributed by shared media to the rest of the home. The Internet is brought to the home as a single insertion point via a Cable or DSL access point and on the other side of an appropriate modem a single Ethernet connection delivers shared access to the Internet. At each of these single access points DMIT inspects information moving in and out of the home. Based on common and media specific rules, DMIT will determine whether or not insertion is necessary.

DMIT is responsible for acquiring knowledge about users and hardware devices that have connections to a shared network access point. Each single media access point then has rules associated with it. Some of these rules may be global to all media access points or to a single media access point. As an example, as the system is aware of the ages of all children within the home, a determination may be made whether or not programming is suitable for the children and take appropriate insertion/replacement actions. Furthering the example, if the system has been given a rule to stop access to inappropriate web sites on the Internet, DMIT will inspect IP packet source, destination, and content if necessary to determine whether a replacement of packets are necessary. In the case of an inappropriate web site, replacement web pages would be delivered to the requesting workstation that might say access to this site is disallowed based on DMIT rules. As a further example, if the School Interface System (SIS) described below schedules a time through the FIS for a child to be doing homework, the DMIT could block video being sent to the child's room for the prescribed time. Also, virus and firewall inspection may also be performed by the DMIT.

DMIT searches the RIR through the Family Information Manager (FIM) to obtain demographic information and to set default rules. Based on these rules DMIT may, as discussed above, communicate with the central entity to build advertising insertions to any media type that is defined as an advertising target.

The DMIT may provide an Application Program Interface for standardized insertion of content into any MPEG2 output multiplex from a splicer. Arbitration may be provided in case of multiple conflicting content splices requests. Messaging may be provided to control switching (insertion & back) splicing requirements (see FIG. 8). The detection and insertion may be provided by a video module, such as that illustrated in FIG. 8 under the control of the DMIT.

Media Insertion may include insertion of home automation information, appliance alerts, refrigerators, water heaters, oven, stove, disaster detection, etc., security information, cameras, perimeter breach detection (infra-red) information, glass break information, audio, child monitoring/remote monitoring, microphone output, crib monitors (distress/SID syndrome), system status including, for example, lights, windows, environmental (heating, cooling, air quality detection), fire monitors, water detection monitors, advertisements, information services, messaging, such as Web tagged input and/or Phone/video phone, user defined information and/or public service announcements (local).

Particular embodiments of a DMIT are further illustrated in FIG. 11. As seen in FIG. 11, the DMIT application may access the RIR through the FIM. The DMIT application may use the information from the RIR to obtain and/or select insertions for inclusion in particular sources, determine a user of display device, determine filtering rules or the like. The DMIT application may provide the information to the DMIT inspect/replace intelligence module that controls the inspect/replace modules for the particular media. The DMIT inspect/replace intelligence may direct the particular media control modules as to when to replace media provided to a user and what will be used to replace the media.

As is illustrated in FIG. 11, the media inspect/replace modules may be provided for different media, such as cable TV, digital satellite (DSS), internet, radio or other media sources. The individual modules configuration will depend on the media being inspected and replaced. Thus, for example, a video module such as that described above with reference to FIG. 8 may be provided for cable television and/or over-the-air television signal inspection and replacement. Similarly, an IP packet filter may be provided that inspects and replaces Internet media. For example, the Internet media may filter IP traffic based on content, such as a source address, destination address, data payload, or the like, and replace particular IP traffic with an insertion. Thus, for example, based on information provided by the DMIT inspect/replace intelligence, if a child accesses a web page that is identified as prohibited, the prohibited web page may be replaced detected and replaced by the Internet Media inspect/replace with an informational web page that indicates that the request page has been blocked.

Family Information Scheduler (FIS)

FIS integrates into the Family Information Manager and maintains its information within the Residential Information Repository. Family members are able to add events to the calendar through the use of the web browser interface. Additionally, the scheduling system is able to synchronize with Personal Information Managers that home users use in their work environment. This capability keeps the home user from having to repeat entry for calendar entries already made at work and allows the family calendar to further synchronize with the work calendar.

Each family member has access to the global family calendar so that the family can make decisions regarding family activity in a glance. Security is setup appropriately for to set what level of detail is viewed or changed by other family members.

Other external activities that a family member might be involved in, such as youth athletics and school schedules, can create a standard formatted schedule that may load up the calendar without user effort to make entries into the calendaring system.

The Family Information Scheduler may be an important component as it provides event driven activities within the system and coordinates with Family Information Manager and activities that must be delivered to other applications such as home automation. As an example, if the calendaring system shows that all family members are outside of the home during a time that the family would otherwise be home, the home lighting and automation control application that is plugged into the Family Information Manager can take action that would be appropriate; in this case maybe only security lights and cameras are triggered on versus all family common room lights on.

As a further example, if the home automation system module captures a maintenance event from an air conditioning unit, the Family Information Manager can lookup within the Residential Information Repository to retrieve the contact information to schedule a house call for maintenance. Prior to sending a standard scheduling request with the maintenance company, the Family Information Scheduler would be check for appropriate dates and would request acceptance of possible dates for scheduling from the appropriate home user.

The Family Information Scheduler or Calendaring system has two types of interfaces, direct and indirect.

The direct calendar interface allows the user to input event information into the Family Information System via standard web browser interface. This information is accumulated within the Residential Information Repository and is acted upon by other applications that have been plugged into the Family Information Manager as appropriate.

Indirect methods include Personal Digital Assistant (PDA) synchronization with the Family Information System or other Family Information Manager Applications that deliver scheduling information due to actions that occur within those applications.

For example, the School Information System may download student event information that has been prepared in an industry standard XML format that is then applied to the Calendar. The downloaded information need not be in a proprietary format as XML describes the data within the file that is being downloaded. Once information is in the Calendar, other applications including the Family Information System will determine actions based on the new homework schedule. If the student user has scheduled events, the Family Information System will indicate conflicts before other activities are scheduled.

This operation is further illustrated by the maintenance event that is captured with the Air Conditioning unit. When the Air Conditioner declared a maintenance event from the Home Automation system module (Resident Aware Controller Control) the application indirectly adds an event to the calendar for action.

Extended Family Information Manager Service

The extended family information manager service provides a secure one-way data synchronization from the RIR to a central entity (off site). The central entity will hold the global information for the extended family. The extended family information manager service will allow family members to view and sync with other family members outside the RIR of each family. Thus, in certain embodiments of the present invention, there is no direct interaction from RIR to RIR in the extranet for the extended family.

Medical Information System (MIS)

The MIS application may allow the secure transfer of the records to the patients home, along with scheduling of medication through FIS. The medical industry is establishing an electronic information system (HIPAA) that will be used by doctors, health insurance agencies, and others within the medical industry. The use of the system is to allow electronic transfer and access to patient medical records in standard format. Also, with the enactment of HIPAA the patients will own their records. This will give way to a means of which transfer and storage of the records will need to be enacted within the patients home. MIS will interact with the FIS to allow doctors to display on the patients televisions every day their schedule dosage of medicine. The patient may even set up a completion task on the Family Calendar to complete the medication dosage. Prescriptions will be digitally stored, changed, and filled by MIS.

School Interface System (SIS)

The SIS application may allow the extraction of on line school assignments and activities to be incorporated into the Family Calendar through FIS. The SIS will enable the head of the family household to monitor the discipline of home-work completion. It will also give a scheduling mechanism to assure completion at the assigned date. SIS is a way for the family to schedule the necessary time in the day to allow for the important completion of school assignments. Along with the interaction for home work, it will interact with FIS to allow the scheduling of teacher conferences, field trips and other events.

Resident Aware Controller Control Application

The Resident Aware Controller Control Application, in conjunction with FIM, can provide the capability of making intelligent home automation decisions. The interaction of information within the RIR and the control application, through the FIM, may give the control application the ability to provide a dynamic environment of home automation programming.

The Resident Aware Controller Control Application is the foundation layer for all types and brands of home automation equipment, but does not actually do the direct controlling of the equipment. Thus, as seen in FIG. 9, the Resident Aware Control Controller application may communicate directly with control modules using a communication protocol of the particular control module (illustrated in FIG. 9 as X-Prot/TCP/IP Port X). These communications may allow the Resident Aware Control Controller application to activate, monitor or otherwise interact with the modules that directly control and/or monitor a home automation, audio/visual and/or other such devices. Control elements, such as lighting, irrigation, HVAC, and audio/video within the Resident Aware Controller Control Application are accessible via a platform independent web browser technology (interaction between HTTP server and the Control Application in FIG. 9).

Resident Aware Controller Services

The Resident Aware Controller Services Application is a push type of informational updating of all the applications. A central entity outside the residence will push updated via the web.

As an example of the operation of particular embodiments of the present invention, an entry is made in the household calendar of the Family Information Scheduler (FIG. 9) to schedule a party. The resident aware controller (i.e., the local system) accepts the entry, recognizes the key word party, and queries the owner with a few questions based upon the keyword. For example:

1. What is the theme of the party?

2. Who will be the attendees?

3. What will be served?

4. What activities are desired and what is the desired order of the activities?

5. What are the constraints for the event with respect to home automation (security, environmental, etc.)?

6. Are any outside services required?

7. Are any products required?

8. Would you like to receive product and service information?

The information gathered through responses to the questions 1-8 above is processed by the appropriate modules, such as the FIS,KIS, etc and the target sub-modules are updated based upon their respective function. Low level modules (i.e. those acting only within the home environment) get updated with a schedule related to the party event. High level modules (outward facing from home) process the input and their resulting content is transferred to the central entity from the Family Information Portal via the residential access point (see FIG. 9 and FIG. 5A).

The central entity receives the high level module information and acts to assemble a package of useful products, services, and assistance. Examples are:

1. Based upon the number of attendees, KIS, activities, and theme the central entity creates a proposal for the food & drink required. This proposal is sent back to the home and placed in a “mailbox” for review by the owner. Once accepted by the owner the details are loaded into affected lower level modules (in this case KIS) and the required goods automatically ordered.

2. The list of attendees is matched to the local database at the central entity and invitations sent to the invited households. RSVPs are tracked and feedback is sent to the home hosting the party with some regular interval. The invitations are produced at the central entity in the form of a video clip with content appropriate to the theme. These are sent for DMIT insertion to invited guest households for airing. For invited guest households which do not accept this form of input for preference reasons or subscribe to the service, simple emails via SMTP are sent.

3. A portfolio of useful products and services which might be applicable for the event are assembled at the central entity. Direct content requests for host identified products or services are directly forwarded by the central entity to the content or service provider. Products or services which are related to the event either by function or theme are identified from the central entity provider list and a portfolio of information assembled. The information is inspected for applicability and ranked according to “usefulness” for the host preferences. (For example, the host may only want a maximum DMIT insertion length of 1 hour over a period of 2 weeks preceding the party.) The ranked information is assembled into a package meeting the host household requirements and transferred via the residential access point to the Family Information Portal. The FIP transfers the information to the DMIT module and the clips are inserted into the appropriate Media Insertion/Replace Module for display during the time slots the home owner has designated as useable. If any of the services or products are of interest to the homeowner they can then contact the provider. Examples of useful products or services could be home cleaning services, catering, rental equipment, etc. Additionally, an event planning progress description media insertion video clip may be constructed locally for display when the homeowner(s) are identified as being present. For example, a video clip with X days to party, Y invitations accepted or the invite list with check marks for acceptance/RSVP displayed, Z days till menu must be finalized, etc. could be inserted to allow the owner to measure progress or be prompted to take actions.

The above describe some outward facing steps which may be taken. The following describes some inward or within the home steps which could be taken in this scenario.

1. The application layer (FIG. 9) could schedule media insertion for particular types for use for the duration of the party. For example the radio content in one location could be chosen to be a particular type of music. The video content could be chosen to be a backdrop representative of an environment consistent with the theme of the party. Announcements of party event location transition points could be inserted. These would be representative of DMIT utilization.

2. The application layer could schedule the environmental operation as appropriate for the party. For example, irrigation could be rescheduled to outside the party hours. HVAC could “pre-condition” the home knowing that the BTU load was to be altered by the number of attendees and an increased number of entrance openings/closings. Lighting could be controlled to provide increased outdoor lighting for safety and location identification enhancement for guests. Indoor lighting could be adjusted for the party and to indicate open and closed areas to the guests.

3. The application layer could identify and place specific actions on household members individual calendars. For example the children could be prompted to perform chores. The homeowners could be prompted to complete preparation actions according to a pre-event schedule.

Thus, as a result of scheduling a party, use of embodiments of the present invention provides for control of aspects of the party in an automated manner. These aspects may be controlled locally or through interaction with the central entity. Such control is not a result of direct user input but is the result of interaction between services/functions provided through the resident aware controller so as to inferentially control the residence based on a resident activity.

The flowcharts and block diagrams of FIGS. 1 through 11 illustrate the architecture, functionality, and operation of possible implementations of systems, methods and computer program products for resident aware home automation according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method of controlling a component of a home management system at a residence, comprising
determining resident activities of a resident of the residence; and
controlling the component based on the determined resident activities of the resident.

2. The method of claim 1, wherein determining resident activities of a resident comprises collecting information on activity schedules of residents of the residence utilizing an electronic calendar.

3. The method of claim 1, wherein controlling the component comprises:
selecting a video insertion to replace a commercial advertising portion of a video stream based on the determined activities of the resident;
detecting a commercial advertising portion of the video stream; and
replacing the detected commercial advertising portion of the video stream with the selected video insertion so as to provide a composite video stream containing primary content portions and the selected video insertion.

4. The method of claim 3, wherein selecting a video insertion comprises selecting an advertisement associated with the determined activities of the resident.

5. The method of claim 1, wherein determining activities of a resident comprises:
maintaining an activities schedule for the resident; and
determining whether the resident is present at the residence based on the resident's activities schedule.

6. The method of claim 5, wherein controlling the component comprises controlling access to video programming and/or network information based on the resident's activities schedule.

7. The method according to claim 2, wherein controlling the component based on the determined resident activities of the resident comprises controlling at least one home management component of the home management system based on the information collected on the activity schedules of the residents.

8. A computer program product comprising a computer readable medium having computer readable program code embodied therein, the computer readable program code being configured to carry out the method of claim 1.

9. A method of displaying a video stream containing commercial advertising portions and primary content portions on a television at a residence, comprising:
detecting a commercial advertising portion of the video stream; and
replacing the detected commercial advertising portion of the video stream with a video stream from a source component located at the residence so as to provide a composite video stream containing primary content portions and at least one locally generated portion.

10. The method of claim 9, wherein the video stream comprises at least one of a camera output and/or a status display.

11. The method of claim 9, wherein the video stream comprises a video stream from a baby monitor.

12. The method of claim 9, further comprising:
collecting information on activity schedules of the residents of the residence;
analyzing the activities reflected in the collected information; and
selecting the video stream from the source component located at the residence based on the analysis of the collected information.

13. The method of claim 12, wherein the information on activity schedules is collected utilizing a calendar application.

14. The method of claim 9, further comprising:
collecting information on resident activities;
analyzing the resident activities reflected in the collected information; and
selecting the video stream from the source component located at the residence based on the analysis of the collected information.

15. A computer program product comprising a computer readable medium having computer readable program code embodied therein, the computer readable program code being configured to carry out the method of claim 9.

16. A method of generating demographic data for residents of a residence for use in selecting video content for presentation to the residents, comprising:
collecting information on activity schedules of the residents of the household;
analyzing the activities reflected in the collected information; and
selecting video content for presentation to the residents on a television based on the analysis of the collected information.

17. The method of claim 16, wherein the information on activity schedules is collected utilizing a calendar application.

18. The method of claim 16, wherein analyzing and selecting comprises:
transmitting at least a portion of the collected information to a central entity; and
receiving video content for presentation to the residents from the central entity.

19. The method of claim 18, wherein the central entity carries out the steps of:
evaluating the transmitted information to determine at least one interest of the resident;
selecting at least one advertiser based on the determined interest; and
forwarding an advertising clip associated with the at least one advertiser to the residence.

20. The method of claim 19, wherein the central entity requests and receives a plurality of advertising clips, the method further comprising:
generating a program package incorporating the plurality of advertising clips; and
sending the program package to the residence.

21. The method of claim 16, wherein analyzing the collected information comprises analyzing the collected information so as to determine an interest of a resident associated with the collected information.

22. A computer program product comprising a computer readable medium having computer readable program code embodied therein, the computer readable program code being configured to carry out the method of claim 16.

23. A method of determining a user of a video display device, comprising:
collecting information on activity schedules of the residents of the residence; and
identifying at least one of the residents of the residence as the user of the video display device based on the collected information.

24. The method of claim 23, wherein the information on activity schedules is collected utilizing a calendar application.

25. The method of claim 23, further comprising selecting video content for display on a display device based on the identified at least one resident.

26. The method of claim 23, wherein identifying at least one resident comprises eliminating from a list of possible users residents that the activity schedule information indicates are not present at the residence.

27. The method of claim 26, further comprising:
collecting information on resident activities associated with corresponding residents;
analyzing the resident activities reflected in the collected information to identify interests of the corresponding residents; and
wherein identifying at least one resident further comprises select a user from the list of possible users based on the interests of the residents and the content of video to be displayed on the display device.

28. The method of claim 27, wherein collecting information on resident activities comprises collecting information utilizing a calendar application.

29. A computer program product comprising a computer readable medium having computer readable program code embodied therein, the computer readable program code being configured to carry out the method of claim 23.

30. A method of controlling components in a home management system, comprising:
maintaining a central repository of residence information for use by more than one component of the home management system; and
determining an action to control a component of the home management system based on an analysis of residence information maintained in the central repository.

31. The method of claim 30, wherein the residence information comprises demographic information of residents, resident activity information and activity schedules of residents.

32. The method of claim 30, wherein determining an action to control a component of the home management system comprises selecting a video insertion to replace a commercial advertising portion of a video stream based on the information stored in the central repository, the method further comprising:
detecting a commercial advertising portion of the video stream; and
replacing the detected commercial advertising portion of the video stream with the selected video insertion so as to provide a composite video stream containing primary content portions and the selected video insertion.

33. The method of claim 32, wherein selecting a video insertion comprises:
transmitting at least a portion of the information from the central repository to a central entity; and
receiving video content for presentation to the residents from the central entity.

34. The method of claim 33, wherein the central entity carries out the steps of:
evaluating the transmitted information to determine at least one interest of the resident;
selecting at least one advertiser based on the determined interest;
requesting an advertising clip from the at least one advertiser;
receiving an advertising client from the at least one advertiser responsive to the request; and
forwarding the received advertising clip to the residence.

35. The method of claim 34, wherein the central entity requests and receives a plurality of advertising clips, the method further comprising:
generating a program package incorporating the plurality of advertising clips; and
sending the program package to the residence.

36. The method of claim 32, wherein selecting an insertion comprises:
analyzing information from the central repository so as to determine an interest of a resident associated with the information; and
selecting a video insertion based on the determined interest of the resident.

37. The method of claim 30, wherein determining an action comprises determining an action to control at least one of a home automation system, a parental control system, a security system, a network firewall, a video system, an audio system, a telephone system and/or a residence monitoring system.

38. The method of claim 30, further comprising controlling access to the central repository with a common interface through which application programs communicate with the central repository.

39. A computer program product comprising a computer readable medium having computer readable program code embodied therein, the computer readable program code being configured to carry out the method of claim 30.

40. A home management system, comprising:
a central repository of residence information;
a family information manager configured to provide access to the central repository of residence information; and
a plurality of home management application program configured to retrieve information from and/or store information in the central repository.

41. The home management system of claim 40, further comprising a family information portal configured to provide an interface to the plurality of application programs.

42. The home management system of claim 40, further comprising a direct media insertion technology (DMIT) module configured to control the content of media distributed to devices managed by the home management system.

43. The home management system of claim 42, wherein the DMIT module is further configured to block access to media based on information in the central repository.

44. The home management system of claim 42, wherein the DMIT is further configured to insert advertisements into media distributed to devices managed by the home management system based on information in the central repository.

45. The home management system of claim 42, wherein the DMIT is further configured to replace advertisements in media distributed to devices managed by the home management system with alternative media content based on information in the central repository.

46. The home management system of claim 40, wherein at least one of the application programs comprises a calendar application for tracking activities of users of the home management system.

47. The home management system of claim 40, wherein at least one of the application programs comprises a services module configured to provide sharing services that control the flow of information from the central repository, an update module that provides for updating the central repository, a Family Information Scheduling (FIS) module that provides a Family Calendar that tracks family activities, appointments and/or tasks, a Family Advertising System (FAS) module that provides tailored advertising and/or control over advertising, a Kitchen Information System (KIS)/Gourmet module provides recipes, menu planning and/or inventory functions, a Medical Information System (MIS) module that provides medical information, maintenance, control over medical records and/or exercise schedules/routines, a Landscape Information System (LIS) module that controls the schedule of maintenance and/or irrigation systems, a School Interface System (SIS) module that tracks assignments and/or activities and/or a Family Automation Control (FAC) module that controls home automation systems.

48. The home management system of claim 40, wherein the plurality of application programs comprise at least two application programs configured to use information provided by the other one of the two application programs.

49. The home management system of claim 48, wherein the information used the one of the two application programs that is provided by the other one of the two application programs is stored in the central repository.

50. A system for controlling a component of a home management system at a residence, comprising
means for determining resident activities of a resident of the residence; and
means for controlling the component based on the determined resident activities of the resident.

51. A system for displaying a video stream containing commercial advertising portions and primary content portions on a television at a residence, comprising:
means for detecting a commercial advertising portion of the video stream; and
means for replacing the detected commercial advertising portion of the video stream with a video stream from a source component located at the residence so as to provide a composite video stream containing primary content portions and at least one locally generated portion.

52. A system for generating demographic data for residents of a residence for use in selecting video content for presentation to the residents, comprising:
means for collecting information on activity schedules of the residents of the household;
means for analyzing the activities reflected in the collected information; and
means for selecting video content for presentation to the residents on a television based on the analysis of the collected information.

53. A system for determining a user of a video display device, comprising:
means for collecting information on activity schedules of the residents of the residence; and
means for identifying at least one of the residents of the residence as the user of the video display device based on the collected information.

54. A system for controlling components in a home management system, comprising:
means for maintaining a central repository of residence information for use by more than one component of the home management system; and
means for determining an action to control a component of the home management system based on an analysis of residence information maintained in the central repository.
